(19) United States
(12) Patent Application Publication
(10) Pub. No.: US 2024/0401656 A1
(43) Pub. Date: Dec. 5, 2024

(54) SHIM FOR BRAKE PAD AND BRAKE PAD THEREOF

(71) Applicant: HL MANDO CORPORATION, Pyeongtaek-si (KR)

(72) Inventor: Hatem SHAHIN, Pfaffenhofen (DE)

(73) Assignee: HL MANDO CORPORATION, Pyeongtaek-si (KR)

(21) Appl. No.: 18/385,088

(22) Filed: Oct. 30, 2023

(30) Foreign Application Priority Data
May 31, 2023 (DE) 102023205097.8

(51) Int. Cl. F16D 65/097; F16D 65/00

(52) U.S. Cl. CPC F16D 65/0971; F16D 65/0006; F16D 2200/0004; F16D 2200/0056; F16D 2200/0065

(57) ABSTRACT

Disclosed herein is a shim for a brake pad including a plurality of first wires made of a plastic material or a rubber material and a plurality of second wires made of a metal material, and the plurality of first wires and the plurality of second wires may be formed in a single sheet shape.

### CROSS-REFERENCE TO RELATED APPLICATION

This application claims priority from Germany Patent Application No. 102023205097.8, filed on May 31, 2023, which is hereby incorporated by reference for all purposes as if fully set forth herein.

### BACKGROUND

### 1. Field

Embodiments of the present disclosure relate to a shim for a brake pad and a brake pad thereof.

### 2. Description of the Related Art

There has been a problem in which squeal and/or squeak noise is generated in a disk brake of a vehicle.

Conventionally, shims are provided between a caliper and a back plate of a brake pad to reduce or remove noise generated from the disk brake. For example, shims (or also referred to as standard adhesive shims) are attached through an adhesive or shims inserted in a rear surface of the back plate of the brake pad are fixed using clips to be fixed and continuous on the rear surface of the back plate.

The conventional shim has a thin thickness and is generally made of a rubber layer and a steel plate, and thus it has advantages of being effective in terms of dynamics and very light in weight.

However, the conventional shim has a disadvantage that it is effective in removing noise only at a specific temperature and in a specific frequency range.

In addition, in the conventional shim, all components of the shim may be compressed due to an adhesive layer and rubber, and when a high pressure (for example, a pressure of 30 bar or more) is applied, a problem such as the shim being separated from the back plate or being pushed to one side (or also referred to as a volume support problem) has occurred. In this manner, the problem such as the conventional shim being separated from the back plate or being pushed to one side causes foreign substances to flow in between the back plate and the shim or a surface pressure to be unstable, causing another problem of deterioration in braking performance of the vehicle.

### SUMMARY

Therefore, it is an aspect of the present disclosure to provide a shim for a brake pad and a brake pad thereof with a new structure that improves the conventional problem described above and has higher weight reduction, rigidity, and damping effect than conventional shims.

Additional aspects of the disclosure will be set forth in part in the description which follows and, in part, will be obvious from the description, or may be learned by practice of the disclosure.

In accordance with one aspect of the present disclosure, a shim for a brake pad includes a plurality of first wires made of a plastic material or a rubber material, and a plurality of second wires made of a metal material, in which the plurality of first wires and the plurality of second wires are formed in a single sheet shape.

The single sheet shape may be formed by the plurality of first wires being disposed in a first direction as a longitudinal direction and the plurality of second wires being disposed in a second direction crossing the first direction as a longitudinal direction.

The single sheet shape may be formed by the plurality of first wires being spaced apart from each other at predetermined intervals and the plurality of second wires being spaced apart from each other at predetermined intervals.

The single sheet shape may be formed with a plurality of curves.

A diameter of each of the plurality of second wires may be included in a range of 0.3 mm or more and 0.5 mm or less.

A thickness of the shim for a brake pad may be included in a range of 0.6 mm or more and 1.2 mm or less.

In accordance with another aspect of the present disclosure, a brake pad includes a friction member in contact with a friction surface of a brake disk, a back plate having front and rear surfaces and supporting the friction member, and a shim disposed on the rear surface of the back plate, in which the shim includes a plurality of first wires made of a plastic material or a rubber material, and a plurality of second wires made of a metal material.

The plurality of first wires may be disposed in a first direction as a longitudinal direction, and the plurality of second wires may be disposed in a second direction crossing the first direction as a longitudinal direction.

The plurality of first wires may be spaced apart from each other at predetermined intervals, and the plurality of second wires may be spaced apart from each other at predetermined intervals.

A diameter of each of the plurality of second wires may be included in a range of 0.3 mm or more and 0.5 mm or less.

A thickness of the shim may be included in a range of 0.6 mm or more and 1.2 mm or less.

The shim may be attached to the rear surface of the back plate through an adhesive.

One surface of the shim that comes into contact with the rear surface of the back plate may be formed with a plurality of curvatures.

The adhesive may fill cavities between the plurality of first wires and the plurality of second wires, and the rear surface of the back plate.

In accordance with still another aspect of the present disclosure, a shim for a brake pad includes a plurality of first wires made of a plastic material or a rubber material, and a plurality of second wires made of a metal material, in which one layer is formed by the plurality of first wires being spaced apart from each other at predetermined intervals in a first direction as a longitudinal direction, and the plurality of second wires being spaced apart from each other at predetermined intervals in a second direction crossing the first direction as a longitudinal direction, and one surface of the layer attached to a back plate of a brake pad is formed with a plurality of curves.

A diameter of each of the plurality of second wires may be included in a range of 0.3 mm or more and 0.5 mm or less.

A thickness of the shim for a brake pad may be included in a range of 0.6 mm or more and 1.2 mm or less.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1A is a view showing a brake pad to which a conventional shim is attached according to one embodiment;

FIG. 1B is a view showing a brake pad to which a conventional shim is attached according to one embodiment;

FIG. 2 is a schematic cross-sectional view of a disk of a brake device and a brake pad structure according to one embodiment;

FIG. 3 is a perspective view of some constituents of a brake pad according to one embodiment;

FIG. 4 is a view showing a side structure of a shim according to one embodiment;

FIG. 5 is a view showing a planar structure of the shim according to one embodiment;

FIG. 6 is a view showing a shim attached to a back plate according to one embodiment;

FIG. 7 is a view showing the arrangement of the shim on the brake device according to one embodiment; and

FIG. 8 is a view showing the arrangement of the shim on the brake device according to one embodiment.

### DETAILED DESCRIPTION

Like reference numbers refer to like components throughout the specification. This specification does not describe all elements of the embodiments, and general content or overlapping content between the embodiments in a technical field to which the present disclosure belongs will be omitted. The term ‘unit, module, member, or block’ used in the specification may be embodied as software or hardware, and a plurality of ‘units, modules, members, or blocks’ may be embodied as one component or one ‘unit, module, member, or block’ may include a plurality of components according to embodiments.

Throughout the specification, when a part is said to be ‘connected’ to another part, this includes not only a case of being directly connected but also a case of being indirectly connected, and the indirect connection includes being connected through a wireless communication network.

In addition, when a part is said to ‘include’ a certain component, this means that it may further include other components without excluding other components unless otherwise stated.

Throughout the specification, when a member is said to be located ‘on’ another member, this includes not only a case where a member is in contact with another member, but also a case where still another member is present between the two members.

Terms such as first and second are used to distinguish one component from another, and the components are not limited by the aforementioned terms.

Singular expressions include plural expressions unless the context clearly dictates otherwise.

In each step, the identification code is used for convenience of description, and the identification code does not describe the order of each step, and each step may be performed in a different order from the specified order unless a specific order is explicitly described in context.

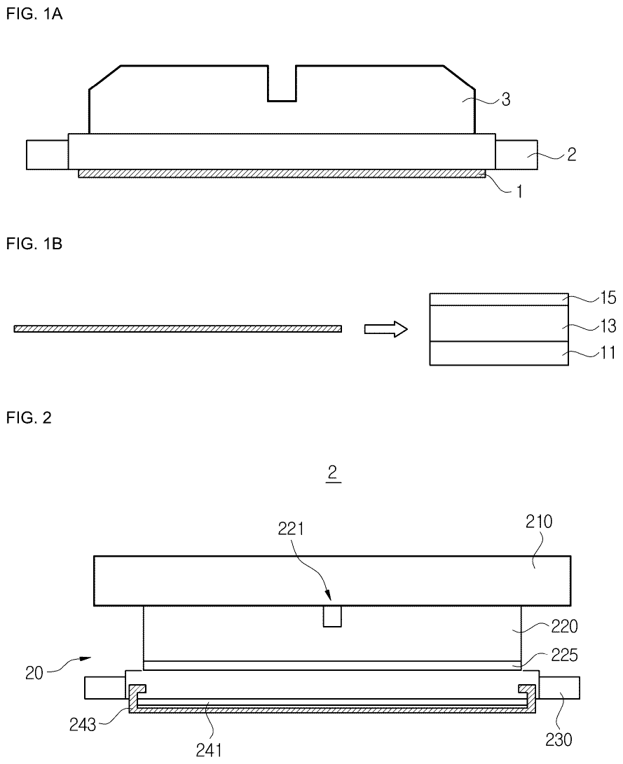

FIGS. 1A and 1B are views showing a brake pad to which a conventional shim is attached according to one embodiment.

Referring to FIG. 1A, a conventional shim 1 may be provided on a rear surface of a back plate 2 supporting a friction material 3.

In addition, referring to FIG. 1B, the conventional shim 1 may include a rubber layer 11, a steel plate layer 13 disposed on the rubber layer 11, and an adhesive layer 15 disposed on the steel plate layer 13.

The conventional shim 1 as shown in FIGS. 1A and 1B have a disadvantage that it is effective in removing noise, that is, squeal and/or squeak noise, only at a specific temperature and in a specific frequency range.

Moreover, when a high pressure is applied to the conventional shim 1 as shown in FIG. 1, a problem such as the shim 1 being separated from the back plate 2 or being pushed to one side (or also referred to as a volume support problem) has occurred.

The present disclosure is directed to providing a shim for a brake pad and a brake pad thereof with a new structure that can improve the problem described above, which is caused by a structure of the shim 1 as shown in FIG. 1.

Hereinafter, a working principle and embodiments of the present disclosure will be described with reference to the accompanying drawings.

FIG. 2 is a schematic cross-sectional view of a disk of a brake device and a brake pad structure 2 according to one embodiment.

Although not shown, the brake device (not shown) may include a housing (or also referred to as a caliper housing) (not shown), a housing finger (or also referred to as a caliper finger) (not shown), and a piston (not shown), and a brake pad 20 may be attached to the housing finger and/or the piston.

The brake pad 20 may be attached to one surface of a disk (or also referred to as a brake disk) 210.

The brake pad 20 may include a friction member 220, an underlayer 225, a back plate 230, a first shim 241, and/or a second shim 243.

The friction member 220 may be formed to be pressed against a friction surface of the disk 210 when the brake device is hydraulically or electrically driven, and when the friction member 220 is engaged with the disk 210, a friction member applied to a conventional brake pad capable of improving the braking performance and providing a heat transfer may be applied. A slot 221 may be provided on an upper side of the friction member 220.

The underlayer 225 may be disposed between the friction member 220 and the back plate 230. For example, the underlayer 225 may be made to have a thickness of 2 mm or more and 3 mm or less.

The back plate 230 may provide structural stability of the brake pad 20, and may be made to have a thickness of, for example, 4 mm or more and 6 mm or less.

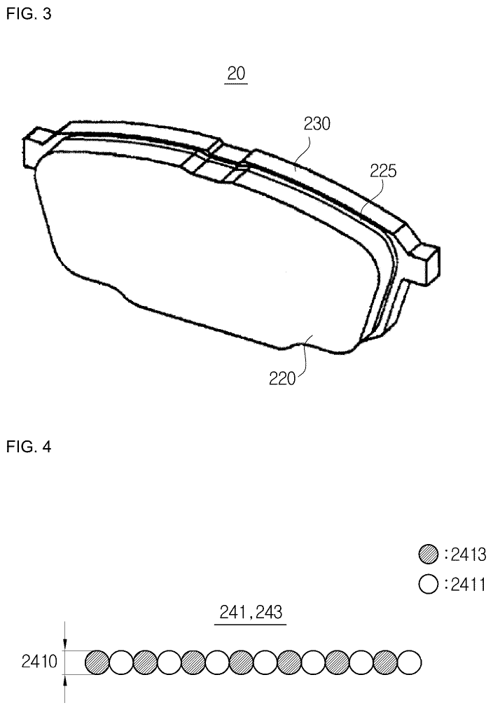

The first shim 241 may be attached (or also referred to as disposed) to a rear surface of the back plate 230. For example, the first shim 241 may be implemented in a structure of FIGS. 3 and/or 4 to be described below, and suppress squeal and/or squeak noise.

The second shim 243 may be provided for additional suppression of the squeal and/or squeak noise, and may be implemented in the structure of FIGS. 3 and/or 4 to be described below.

For example, the second shim 243 may be a clip-type shim with a clip or tab or a cover shim. The second shim 243 may be provided to be in contact and engaged with an edge surface of the back plate 230 for attachment to the back plate 230.

In some embodiments, the first shim 241 and the second shim 243 may adhere to each other.

The second shim 243 may cover a rear surface of the first shim 241, and the first shim 241 may be disposed between the second shim 243 and the back plate 230. Accordingly, the second shim 243 may form an outer shim, and the first shim 241 may form an inner shim.

In the following description, each of the first shim 241 and the second shim 243 is referred to as a shim.

FIG. 3 is a perspective view of some constituents of the brake pad 20 according to one embodiment.

Referring to FIG. 3, the friction member 220 of the brake pad 20 may be disposed on a front surface of the back plate 230. The back plate 230 may have the front surface that comes into contact with the friction member 220 and the rear surface to which the shim 241 (not shown in FIG. 3) is attached. The underlayer 225 may be disposed between the friction member 220 and the back plate 230.

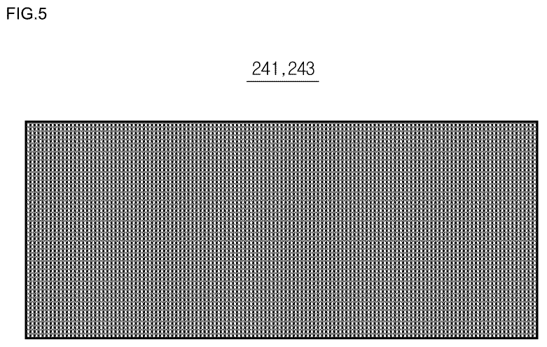

FIG. 4 is a view showing a side structure of the shims 241 and 243 according to one embodiment, and FIG. 5 is a view showing a planar structure of the shims 241 and 243 according to one embodiment.

Referring to FIG. 4, the shims 241 and 243 may include a single sheet-shaped layer 2410 formed of a plastic material or a rubber material and a metal material. For example, the single sheet shape may be formed with a plurality of curves.

Referring to FIGS. 4 and 5, the layer 2410 may include a plurality of first wires 2411 and a plurality of second wires 2413.

The first wires 2411 may include a wire made of a plastic material or a wire made of a rubber material. For example, the plastic material may include various materials such as polypropylene (PP) or polyethylene (PE).

The second wires 2413 may include a wire made of a metal material. For example, the second wires 2413 may be made of steel having a diameter within a range of 0.3 mm or more and 0.5 mm or less.

The plurality of first wires 2411 and the plurality of second wires 2413 may be made in a single sheet shape.

Referring to FIG. 5, the plurality of first wires 2411 and the plurality of second wires 2413 may be arranged in a lattice shape (or also referred to as a mesh shape).

For example, the plurality of first wires 2411 may be spaced apart from each other at predetermined intervals in a first direction as a longitudinal direction. In addition, the plurality of second wires 2413 may be spaced apart from each other at predetermined intervals in a second direction crossing the first direction, as a longitudinal direction, at a top or bottom of the arrangement of the plurality of first wires 2411.

The shims 241 and 243 having such structural characteristics may have a smaller thickness than that of the conventional shim (for example, the shim 1 of FIG. 1).

For example, each of the shims 241 and 243 may be made to have a thickness within a range of 0.6 mm or more and 1.2 mm or less.

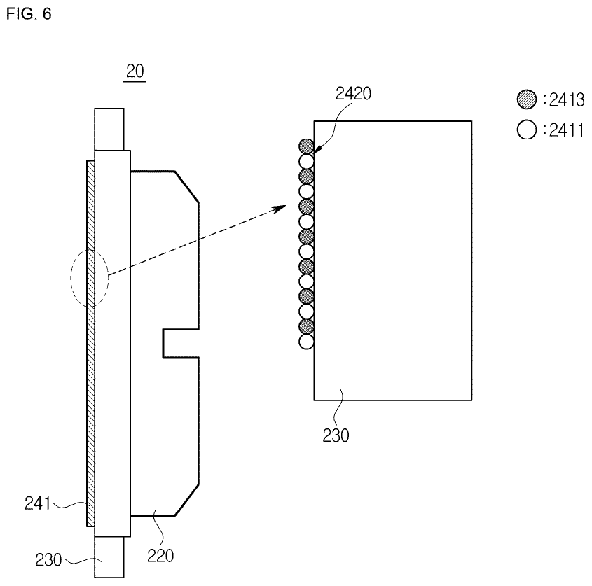

Meanwhile, although not shown in FIGS. 4 and 5, each of the shims 241 and 243 may further include an adhesive (not shown) (for example, an adhesive 2420 in FIG. 6). For example, the adhesive (not shown) (for example, the adhesive 2420 in FIG. 6) may be disposed on, that is, applied to, one surface and/or the other surface of the layer 2410.

The adhesive (not shown) (for example, the adhesive 2420 in FIG. 6) may be a product having strong adhesive force, and may be one of adhesives applied to conventional brake pads.

FIG. 6 is a view showing the shim 241 attached to the back plate according to one embodiment.

Referring to FIG. 6, the shim 241 may be attached to the rear surface of the back plate 230 supporting the friction member 220 through the adhesive 2420.

When the shim 241 is attached to the rear surface of the back plate 230 through the adhesive 2420, since the first wires 2411 and the second wires 2413 are in a cylinder shape (or also referred to as a tube shape), a plurality of curvatures may be formed on one surface of the shim 241 that comes into contact with the rear surface of the back plate 230. Accordingly, many cavities may be formed between the rear surface of the back plate 230 and the shim 241, and the adhesive 2420 may fill the cavities. As many cavities between the rear surface of the back plate 230 and the shim 241 are filled with the adhesive 2420, the shim 241 may have a higher rigidity than the conventional shim (for example, the shim 1 in FIG. 1).

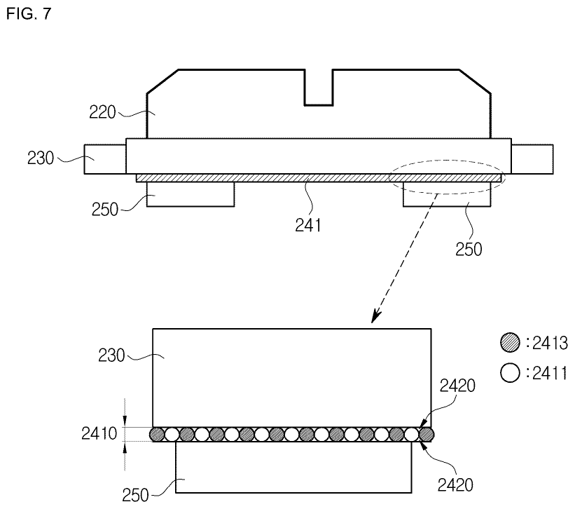

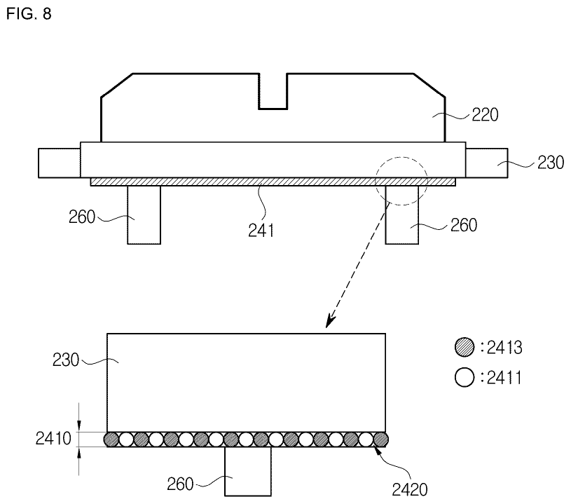

FIGS. 7 and 8 are views showing the arrangement of the shim on the brake device according to one embodiment.

Referring to FIG. 7, the shim 241 may be disposed between the back plate 230 supporting the friction member 220 and the (outer) housing finger 250.

For example, the adhesive 2420 fills cavities between the rear surface of the back plate 230 and one surface of the layer 2410, that is, the first wires 2411 and the second wires 2413, so that one surface of the shim 241 may be attached to the rear surface of the back plate 230. In addition, the adhesive 2420 fills cavities between one surface of the housing finger 250 and the other surface of the layer 2410, that is, the first wires 2411 and the second wires 2413, so that the other surface of the shim 241 may be attached to the one surface of the housing finger 250.

Referring to FIG. 8, the shim 241 may be disposed between the back plate 230 supporting the friction member 220 and the (inner) piston 260.

For example, the adhesive 2420 fills cavities between the rear surface of the back plate 230 and the one surface of the layer 2410, that is, the first wires 2411 and the second wires 2413, so that the one surface of the shim 241 may be attached to the rear surface of the back plate 230. In addition, the adhesive 2420 fills cavities between one surface of the piston 260 and the other surface of the layer 2410, that is, the first wires 2411 and the second wires 2413, so that the other surface of the shim 241 may be attached to the one surface of the piston 260.

Referring to FIGS. 7 and 8, it can be seen that the shim 241 of the present disclosure may have an increasing curvature surface in contact with the (outer) housing finger 250 and/or the (inner) piston 260 compared to the conventional shim according to the structure, which can lead to more contact damping effects that increase the effect of mode decoupling.

Meanwhile, among the components in the embodiment described above, components that come into contact with each other may be coupled (or attached) to each other through an adhesive or the like.

A shim for a brake pad in accordance with one aspect of the present disclosure can provide a higher weight reduction and damping effect than a conventional shim by applying new design and material thereto.

In addition, a shim for a brake pad in accordance with one aspect of the present disclosure can solve a problem such as the conventional shim being separated from the back plate or being pushed to one side and a problem of deterioration in braking performance of a vehicle caused by the occurrence of such a problem by providing higher rigidity than a conventional shim.

Moreover, a brake pad including a shim for a brake pad to which new design and material are applied in accordance with one aspect of the present disclosure can provide a higher damping effect than a conventional brake pad.

As described above, the disclosed embodiment has been described with reference to the accompanying drawings. Those skilled in the art to which the present disclosure pertains will understand that the present disclosure can be implemented in a form different from the disclosed embodiment without changing the technical concept or essential features of the present disclosure. The disclosed embodiment is illustrative and should not be construed as limited.

What is claimed is:

1. A shim for a brake pad comprising:
a plurality of first wires made of a plastic material or a rubber material; and
a plurality of second wires made of a metal material,
wherein the plurality of first wires and the plurality of second wires are formed in a single sheet shape.

2. The shim for a brake pad according to claim 1, wherein the single sheet shape is formed by the plurality of first wires being disposed in a first direction as a longitudinal direction and the plurality of second wires being disposed in a second direction crossing the first direction as a longitudinal direction.

3. The shim for a brake pad according to claim 2, wherein the single sheet shape is formed by the plurality of first wires being spaced apart from each other at predetermined intervals and the plurality of second wires being spaced apart from each other at predetermined intervals.

4. The shim for a brake pad according to claim 3, wherein the single sheet shape is formed with a plurality of curves.

5. The shim for a brake pad according to claim 1, wherein a diameter of each of the plurality of second wires is included in a range of 0.3 mm or more and 0.5 mm or less.

6. The shim for a brake pad according to claim 1, wherein a thickness of the shim for a brake pad is included in a range of 0.6 mm or more and 1.2 mm or less.

7. A brake pad comprising:
a friction member in contact with a friction surface of a brake disk;
a back plate having front and rear surfaces and supporting the friction member; and
a shim disposed on the rear surface of the back plate,
wherein the shim includes a plurality of first wires made of a plastic material or a rubber material and a plurality of second wires made of a metal material.

8. The brake pad according to claim 7, wherein:
the plurality of first wires are disposed in a first direction as a longitudinal direction; and
the plurality of second wires are disposed in a second direction crossing the first direction as a longitudinal direction.

9. The brake pad according to claim 8, wherein the plurality of first wires are spaced apart from each other at predetermined intervals, and the plurality of second wires are spaced apart from each other at predetermined intervals.

10. The brake pad according to claim 7, wherein a diameter of each of the plurality of second wires is included in a range of 0.3 mm or more and 0.5 mm or less.

11. The brake pad according to claim 7, wherein a thickness of the shim is included in a range of 0.6 mm or more and 1.2 mm or less.

12. The brake pad according to claim 7, wherein the shim is attached to the rear surface of the back plate through an adhesive.

13. The brake pad according to claim 12, wherein one surface of the shim that comes into contact with the rear surface of the back plate is formed with a plurality of curvatures.

14. The brake pad according to claim 13, wherein the adhesive is filled cavities between the plurality of first wires and the plurality of second wires, and the rear surface of the back plate.

15. A shim for a brake pad comprising:
a plurality of first wires made of a plastic material or a rubber material; and
a plurality of second wires made of a metal material,
wherein one layer is formed by the plurality of first wires being spaced apart from each other at predetermined intervals in a first direction as a longitudinal direction and the plurality of second wires being spaced apart from each other at predetermined intervals in a second direction crossing the first direction as a longitudinal direction, and
one surface of the layer attached to a back plate of a brake pad is formed with a plurality of curves.

16. The shim for a brake pad according to claim 15, wherein a diameter of each of the plurality of second wires is included in a range of 0.3 mm or more and 0.5 mm or less.

17. The shim for a brake pad according to claim 15, wherein a thickness of the shim for a brake pad is included in a range of 0.6 mm or more and 1.2 mm or less.
